(19) United States
(12) Patent Application Publication
(10) Pub. No.: US 2023/0406767 A1
(43) Pub. Date: Dec. 21, 2023

(54) WATER-FREE AND CEMENT-FREE DUCTILE CONCRETE AND SOIL STABILIZING COMPOSITION AND THERMAL CASTING METHOD FOR MAKING SAME

(71) Applicant: KING SAUD UNIVERSITY, RIYADH (SA)

(72) Inventors: REFAT EL-SHEIKHY, RIYADH (SA); ABDULLAH ABDURAHMAN ALMAJED, RIYADH (SA); MOSLEH ALI AL-SHAMRANI, RIYADH (SA)

(21) Appl. No.: 18/112,327

(22) Filed: Feb. 21, 2023

Related U.S. Application Data
(60) Provisional application No. 63/352,620, filed on Jun. 15, 2022.

(51) Int. Cl. C04B 20/00; C04B 24/26; C04B 14/10; C04B 41/00; C04B 40/00; C04B 14/06; C04B 14/36

(52) U.S. Cl. CPC C04B 20/0004; C04B 24/2611; C04B 14/104; C04B 20/0008; C04B 41/0072; C04B 2111/1037; C04B 14/106; C04B 40/0085; C04B 14/06; C04B 14/361; C04B 20/0096

(57) ABSTRACT

Clay polymer nanocomposites may be mixed with an aggregate material and heat treated to make a structural stabilizer. In an embodiment, the composition is a structural stabilizer resulting from thermal casting and heat treatment. The structural stabilizer does not include cement or water. The heat treatment may be any suitable heat application, including microwave heating, convection oven heating or heating in thermal mixers. The structural stabilizer can be rapidly synthesized to provide high compressive strength and high homogeneity, and to be substantially free of fractures and cracks. Methods of repairing cracks in concrete and stabilizing soil, rock and sand dune formations using the structural stabilizer include thermal casting. Thermal casting ductile concrete molds can include a coating of aluminum foil. The concrete is self-compact, ecofriendly, lightweight, self-repairing and self pre-stressing with homogeneity and low density. The concrete resists steel corrosion, sudden collapse, and does not produce pollution.

### BACKGROUND

### 1. Field

The disclosure of the present patent application relates to a ductile concrete and soil stabilizing composition, and particularly, to a ductile concrete and soil stabilizing composition that includes clay-based polymer nanocomposites and does not include water and cement.

### 2. Description of the Related Art

Conventional concrete is composed of cement, coarse aggregates, fine aggregates and water, as well as other additives. Conventional concrete features many disadvantageous properties and contributes to environmental problems. For example, commonly used Portland cement concrete is brittle, prone to cracking, heavy, non-homogeneous, corrosive to steel, weakly bonding to steel, polluting, harmful to the environment, prone to crushing, easily cracked (i.e., through water absorption and/or shrinking), prone to crack propagation, difficult to repair, not thermally or electrically insulating, and weak in shear and tension strength. Additionally, conventional Portland cement concrete requires water curing to harden, is slow to harden, and is difficult to mix and cast.

Conventional building material compositions used for stabilization of soil, sand, fractured rock and excavation typically use petroleum products that are not ecofriendly and cause pollution.

Polymer-based materials may provide an alternative to existing concrete binders and structural stabilizers. However, many polymers are easily degradable and polymer-based materials often feature low tensile strength, low toughness, and other physical properties that lead to material deterioration, fracture, cracking and failure. There are several types of degradation processes, for example, thermal degradation, chemical degradation, environmental stress cracking, environmental stress fracture, stress corrosion, hydrogen embrittlement, biological degradation, thermal de-polymerization, and UV degradation and oxidation. Thermal degradation occurs by de-polymerization and side-group elimination. Chemical degradation may be caused by, for example, ozonolysis, oxidation, galvanic action, and chlorine-induced cracking, as chlorine is highly reactive. Environmental stress cracking and fracture are substantial causes of brittle failure of thermoplastics.

There are several approaches to polymer stabilization for reducing degradation, including incorporating additives, such as anti-oxidants, anti-ozonants, and UV absorbers to the polymer-based materials. Degradation of polymeric materials alters mechanical properties, such as tensile strength, and other physical properties, such as color and shape. Degradation often occurs by environmental factors such as exposure to high temperatures or direct sunlight and contact with chemicals, leading to crack formation in polymers and polymer-based materials.

The different types of polymer degradation (thermal, mechanical, chemical and biological) have similar mechanisms. As in the case of thermal degradation, chemical degradation is often initiated by oxidation in combination with thermal stresses on the polymers, followed by branching, bifurcation, termination, and separation, producing total failure.

Polymeric materials constitute a significant source of waste, globally. Polymeric materials can potentially be a significant resource, if properly recycled. Use of polymer-based waste in low-cost domestic green material can provide enhanced mechanical properties, thermal properties, fracture and degradation resistant properties over the original properties.

Anti-oxidants and stabilizers may be added to polymers for such enhancement of polymer properties. However, while stabilization has previously been achieved to some degree, it has been difficult to prevent polymer degradation in the past. Chemical additives have additional drawbacks including leaching and polluting.

Thus, a ductile concrete and soil stabilizing composition solving the aforementioned problems is desired.

### SUMMARY

A water-free and cement-free ductile concrete and soil stabilizing composition can include a clay-based polymer nanocomposite (CPNC) and an aggregate material. The clay-based polymer nanocomposite can include a polymer and clay nanoparticles. The clay nanoparticles can be exfoliated and dispersed in the polymer. The aggregate material can include at least one of a fine aggregate and a coarse aggregate. In an embodiment, the polymer can include at least one of a high density polyethylene, a medium density polyethylene, a crosslinked polyethylene, an ultra-high molecular weight polyethylene, a low density polyethylene, and a linear low-density polyethylene. In an embodiment, the polymer includes a combination of a high-density polyethylene and a linear low-density polyethylene. In a particular embodiment, the clay nanoparticles can include nanoparticles of at least one of a montmorillonite clay and a halloysite clay. The montmorillonite nanoparticles may be in the form of nanoplatelets and the halloysite nanoparticles may be in the form of nanotubes.

A weight ratio of the clay nanoparticles to polymer can be in the range of about 1-20%, e.g., about 5%. A weight ratio of aggregate to the nanocomposite of clay and polymer can be in the range of about 1-30%, e.g., about 5-20%.

In a particular embodiment, the aggregate of the composition can include soil or sand from a natural sand or soil-based environment and the composition can be placed in the natural environment to increase stability and/or reduce erosion of the soil or sand.

Another aspect of the present subject matter is directed to a method of preparing a composition comprising providing a powder of a clay-based polymer nanocomposite, mixing the powder with an aggregate that comprises at least one of a fine aggregate and a coarse aggregate to form a mixture, and heating the mixture. The clay-based polymer nanocomposite can include a polymer and clay nanoparticles. The clay nanoparticles can be exfoliated and dispersed in the polymer. In an embodiment, the heating is performed in a thermal mixer under mixing. The mixture can be cast in a mold before heating. The heating may be performed by microwave or convection oven heating.

These and other features of the present subject matter will become readily apparent upon further review of the following specification.

### BRIEF DESCRIPTION OF THE DRAWINGS

FIG. 1 is a diagram showing the stages of manufacturing the ductile concrete and stabilizing composition from the CPNC and the aggregates according to the present teachings.

FIGS. 2A-2B schematizes 2(A) a sand particle surrounded by CPNC particles according to the present teachings; 2(B) a homogenous CPNC particle made of melted polymer and dispersed MMT nanoclay or Halloysite nanotube particles with uniform distribution of nanoclay in the polymer matrix according to the present teachings.

FIG. 3 schematizes sand particles surrounded by CPNC particles under heating according to the present teachings.

FIG. 4 schematizes mixed coarse aggregate particles and sand particles surrounded by CPNC particles under heating according to the present teachings.

FIGS. 5A-5C depicts the steps for making the composition with 5(A) showing an SEM image and corresponding schematic of CPNC particles surrounding sand particles; 5(B) showing an SEM image corresponding schematic depicting cement-free concrete including sand particles and CPNC particles surrounding the sand particles; and 5(C) showing an SEM image and corresponding schematic of cement-free concrete including coarse aggregate particles and sand particles surrounded with CPNC particles.

FIGS. 6A-6C depict 6(A) an image of a special form for casting cubes of CPNC-Concrete; 6(B) an image of cubes of CPNC-concrete coated with aluminum foil; and 6(C) an image of cubes of CPNC-concrete with the foil removed.

FIGS. 7A-7C depict 7(A) cylinders of the cement-free, water-free concrete in the oven; 7(B) a side view of the cylinders of the cement-free, water-free concrete wrapped in aluminum foil; and 7(C) a plan view of the cylinders of the cement-free, water-free concrete.

FIGS. 8A-8B depict 8(A) a mold for the concrete beams coated with aluminum foil; and 8(B) cement-free and water-free concrete beams.

FIG. 9 depicts a slab of stabilizer for use in sand dunes.

FIG. 10 depicts a graph of load-displacement of concrete including the cement-free and water-free fine composition under compression.

FIG. 11 depicts a graph of load-displacement of concrete including the cement-free and water-free coarse composition under compression.

Similar reference characters denote corresponding features consistently throughout the attached drawings.

### DETAILED DESCRIPTION OF THE PREFERRED EMBODIMENTS

A ductile concrete and soil stabilizing composition can include a clay-based polymer nanocomposite (CPNC) and an aggregate material. The clay-based polymer nanocomposite can include a polymer and clay nanoparticles. The clay nanoparticles can be exfoliated and dispersed in the polymer. The aggregate material can include at least one of a fine aggregate and a coarse aggregate. In an embodiment, the polymer can include at least one of a high density polyethylene, a medium density polyethylene, a crosslinked polyethylene, an ultra-high molecular weight polyethylene, a low density polyethylene and a linear low-density polyethylene. In a particular embodiment, the polymer includes a combination of a high-density polyethylene and a linear low-density polyethylene. In a particular embodiment, the clay nanoparticles can include nanoparticles of at least one of a montmorillonite clay and a halloysite clay. The montmorillonite nanoparticles may be in the form of nanoplatelets and the halloysite nanoparticles may be in the form of nanotubes.

The aggregate material may include at least one of a coarse aggregate and a fine aggregate. The aggregate material can include inert granular materials such as sand, gravel, or crushed stone that are typically used in existing concrete. In an embodiment, the coarse aggregate can include at least one of gravel, dolomite, and basalt. The fine aggregate can include at least one of sand and soil. The ductile concrete and soil stabilizing composition according to an embodiment can include or consist essentially of at least one of coarse and/or fine aggregates in a CPNC matrix. Fine aggregates are defined as (1) aggregate passing the 9.5 mm sieve, almost entirely passing the 4.75 mm sieve, and predominantly retained on the 75 μm (No. 200) sieve; (2) that portion of aggregate passing the 4.75 mm (No. 4) sieve and predominantly retained on the 75 μm (No. 200) sieve. Fine aggregates, as described herein, can have a typical size of 0.5-2 mm. Coarse aggregates are the aggregates predominantly retained on the 4.75 mm (No. 4) sieve or that portion retained on the 4.75 mm (No. 4) sieve. Coarse aggregates, as described herein, have a typical size larger than about 2 mm. In an embodiment, the ductile concrete and soil stabilizing composition does not include cement or water.

The ductile concrete and soil stabilizing composition can be used as concrete, a concrete filler, or as a soil stabilizer. The composition can be homogenous, low-density, self-compacting, ductile, and ecofriendly, with controllable porosity and density. The composition can be resistant to fracture, sudden failure and crushing, can absorb strain energy and carry high stress with low energy dissipation. The composition can self-repair if it becomes cracked or otherwise defective. The composition can be prepared using a thermal casting technique with heating by microwave, convection oven or thermal mixer. The composition can be fast processing, achieving high strength rapidly, for example, in a few hours depending on the size and shape of casting or where it is being sintered. The ductile concrete and soil stabilizing composition does not require curing. The ductile concrete and soil stabilizing composition is fire resistant and fire retardant. The ductile concrete and soil stabilizing composition resists dynamic loads, has high fracture toughness, fracture energy and high strength without additional additives, although additives may be added. The ductile concrete and soil stabilizing composition has low thermal conductivity, which controls heat transfer.

The composition can be sintered with no external load or pressure to form both the ductile concrete and the soil stabilizing composition. In embodiments wherein the composition is cast and sintered, the only load is the weight of the composition, causing self-compaction as the composition is heated to the melting point of the CPNC. Cooling time can affect the casing time, strength, fracture toughness and material brittleness, where the sudden cooling or rapid cooling can produce more brittle functional material with glassy behavior. The ductile concrete or soil stabilizer formed from the composition may be a glass due to glass transition of the polymeric components with sudden cooling. Such glassy structural stabilizer may be particularly suitable for certain applications, such as decorations with structural function.

According to an embodiment, the composition consists essentially of aggregates and CPNC. The aggregates may include coarse aggregates (e.g., gravel, dolomite, basalt, etc.) and/or fine (e.g., sand) aggregates. In an embodiment, the ratio of coarse aggregate to fine aggregate can be 2:1.

CPNC refers to a clay-based polymer nanocomposite that includes a polymer matrix reinforced with nanoclay, i.e., nanoscale structures of layered mineral silicates. “Nanoscale” refers to dimensions from 1 nm to 999 nm. The nanoscale structures may be nanoscale in 1-3 dimensions, i.e., nanoplatelets, nanosheets (wherein the nanoscale dimension is an order of magnitude smaller than the other two dimensions), nanotubes or nanoparticles, respectively. In an embodiment of the present subject matter, the CPNC comprises montmorillonite (MMT) nanoplatelets and halloysite clay nanotubes. The polymer is, in an embodiment, HDPE, LLDPE, LDPE, or another class of polyethylene or polymer having similar mechanical and chemical properties. The MMT nanoclay platelets (silicate aluminum) have layers with a thickness of around 1 nm, length of 400 nm and width of 200 nm. The halloysite nanotubes (HNT) may have an external diameter of about 50 nm, an internal diameter of about 15 nm and a length ranging from about 500 nm to about 1000 nm. The chemical composition of MMT is (Na, Ca)_{0.33}(Al, Mg)₂(Si₄O₁₀). The chemical composition of HNT is Al₂Si₂O₅(OH)₄.

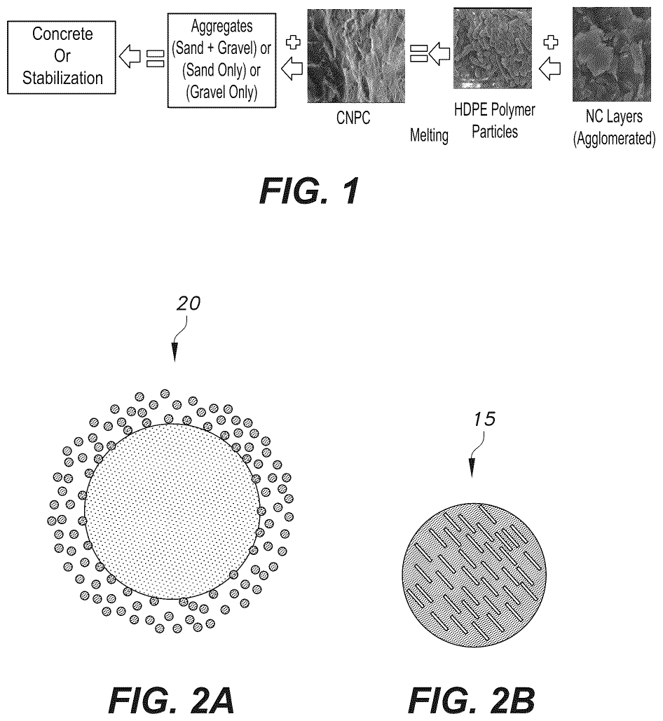

Referring to FIG. 1, the CPNC can be produced by mixing nanoclay with melted polymer under high shear and thermal mixing. The nanoclay may be mixed with the polymer at a weight ratio of 1-20%, 5-10%, or 5%. The high shear and thermal mixing may be achieved by any suitable means, such as extrusion, e.g., using twin screw extruders. In the case of the polymer being a high density polyethylene polymer, the temperature can be 220° C., for example. The clay nanoparticles can be exfoliated and dispersed by the high shear in the polymer matrix to produce CPNC. FIG. 1 depicts the stages of manufacturing the ductile concrete and stabilizing composition as well as SEM images of the HDPE powder, the clay-based polymer nanocomposite, and the resulting CPNC. As heating can create an interfacial bond between the aggregate particles, water is not needed. This differs from methods of preparing conventional Portland cement, which requires water for cement hydration. The resulting composition is ductile, thermally resistant, fire retarding, degradation resistant, and brittle fracture resistant. For these reasons, CPNC is a high functional material for use in structural or stabilizing applications. CPNC can be produced in different forms, including fine powders with particles in nanoscale or microscale (i.e., from 1 μm to 999 μm), or larger scale pellets in the millimeter scale.

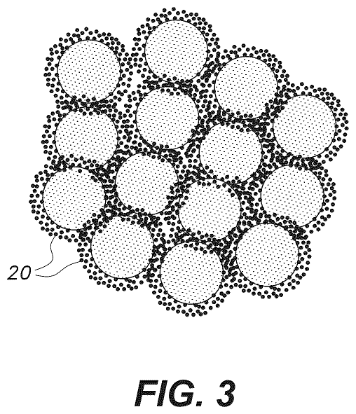

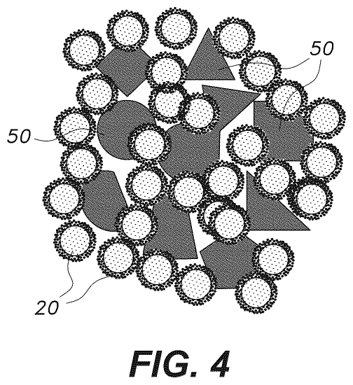

When mixed with the aggregate material, CPNC covers a surface of each aggregate particle and fills the surface between any spaces or pores between aggregates in bulk (see FIGS. 2A-4). When exposed to heat from microwaves or other suitable ovens or heat mixers at a degree of temperature sufficiently near the melting point of the CPNC based on its original components, the CPNC powder can melt to become a continuum material including the aggregates and reinforcing clay nanoparticles. Hardening occurs during cooling, resulting in a composition capable of high energy absorption and strength. During heating, the aggregates coated with CPNC powder rearrange based on their own weight and the viscosity of the CPNC (self-compact), producing dense material that is low weight in comparison to conventional concrete. In an embodiment where the composition is cast in a mold, particularly a metal mold, the material will be prestressed during cooling, due to the contraction of the molds. The voids between aggregates will be self-compacted by weight based on aggregate properties and weight, casting shape, ratio of CPNC to aggregates and cooling. The resulting material can be produced as nonporous to porous.

In an embodiment of the present composition, a ratio of the CPNC to the aggregate may be between 5%-15% by mass. The ratio of CPNC to the aggregate affects the strength, density, porosity and specific weight of the structural stabilizer.

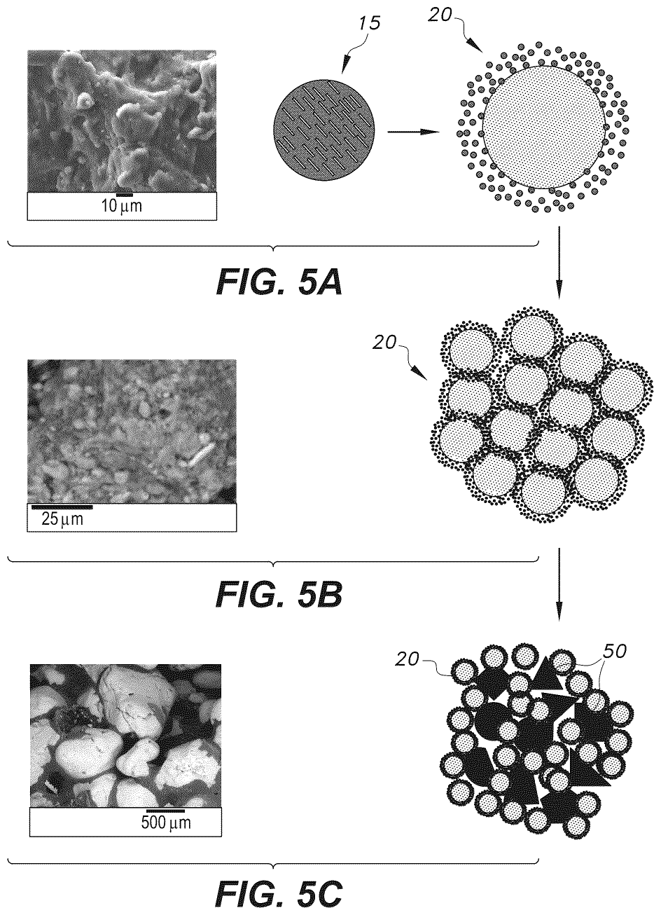

A method of synthesizing the composition can include mixing fine aggregate materials, if used, and a dry powder of the CPNC for several minutes or until the fine aggregates are coated with the CPNC powder, as shown in FIGS. 5A-5B. As shown in FIG. 5C, the method may also include adding coarse aggregates and mixing for several minutes until the coarse aggregates are well coated and dispersed in the dry powder of the CPNC coated fine aggregates and/or the CPNC, alone.

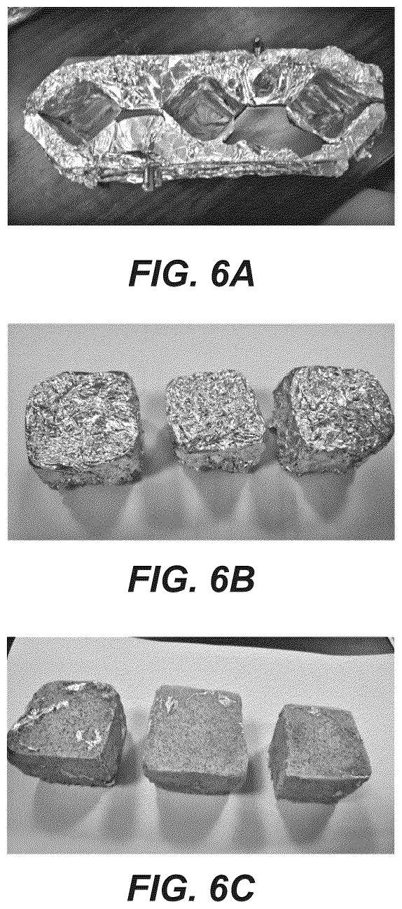

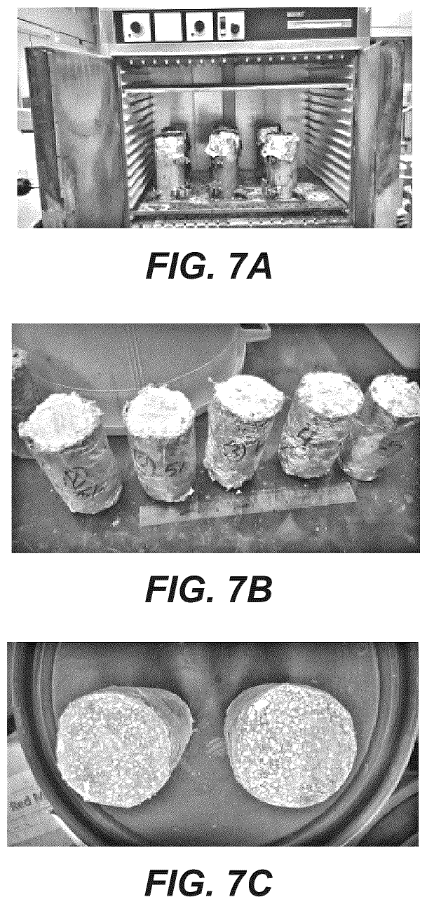

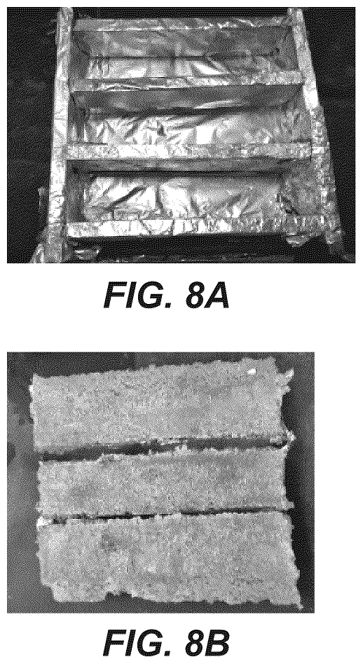

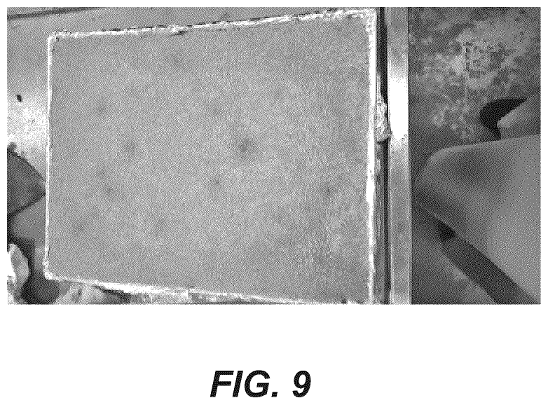

In one embodiment, the composition may be heated in a hot mixer at a temperature that is at least at or near the melting point of the polymer in the CPNC. This mixing may be done until the polymer is melted substantially or completely. The heated mixture can then be cast in a suitable mold and cooled to provide a thermally cast composition. It should be understood that the mixture can be cast in a mold before heating. The cooling may be natural atmospheric cooling or accelerated by any suitable means (i.e., refrigeration, application of cooled air, etc.). Artificial cooling may decrease strength or increase likelihood of cracks in the resulting structural stabilizer. Natural cooling time depends on the shape and size of the mold and mold material but may take a few hours. The resulting thermally cast composition, e.g., concrete or soil stabilizer, does not require curing. The concrete or soil stabilizer may be removed from the molds, which may have been prefilled with aluminum sheets, plastic sheets or CPNC sheets, for example. FIG. 6A shows molds prefilled with aluminum sheets and FIGS. 6B-6C show cubes of the CPNC-concrete. FIGS. 7A-7C show cylinders of the cement-free, water-free concrete in the oven. FIG. 8A depicts a mold for the concrete beams coated with aluminum foil. FIG. 8B depicts the cement-free and water-free concrete beams. FIG. 9 depicts a slab of the soil stabilizer for use in sand dunes.

In another embodiment, the dry mix may be placed in the desired molds and heated in the molds by microwave or a convection oven, for example, to prepare separate pre-cast elements. In the case of the polymer being high density polyethylene polymer, the temperature can be at least about 220° C., e.g., from about 220° C. to about 230° C. The temperature and heating time control the strength of the resulting composite material once set. The composition can compact by self-compaction under the weight of the aggregates therein. The microstructure and particle arrangement of the composition after heating depends on the temperature and ratio of CPNC to aggregates, as well as mold material and shape to some degree. Molds made of metal, for example, can expand during casting and contract after cooling, which can cause self-pre-stressing on the composition and, thereby increase the strength of the resulting material. Pre-casting can avoid any cracking or fracture. The resulting material can be easily recycled or repaired by heating. The specific weight of the resulting material prepared as above can range from about 1.5-1.8 ton/m³.

In the above methods, using a CPNC powder as prepared above, as opposed to nanoclay and polymer separately, and successively coating the fine and course aggregates reduces or eliminates absorption of water from the atmosphere or contaminants by the nanoclay and allows for ultimately well mixed and uniformly coated aggregates that are in turn uniformly suspended in the final composition. Preparing CPNC powder with disaggregated and exfoliated clay nanoparticles therein keep the nanoclay from subsequently absorbing water or aggregating, as it is embedded in the polymer. Producing CPNC by exfoliating and dispersing nanoclay layers in the polymer matrix through high shear extrusion results in uniformly and well incorporated nanoclay platelets and nanotubes, or other nanoscale structures if desired.

According to the present method, by mixing fine aggregates with CPNC dry powder, each fine aggregate gets coated with the CPNC dry powder and, similarly, the coarse aggregates are coated during the second mixing. Mixing as such followed by the heating step ensures every aggregate is coated with melted CPNC, resulting in high bond strength. This strength is reinforced by the nano clay platelets or nano clay nanotubes. After cooling, a high interfacial bond is achieved without defects, fractures or cracks, producing high ductile bonding material with the aggregates.

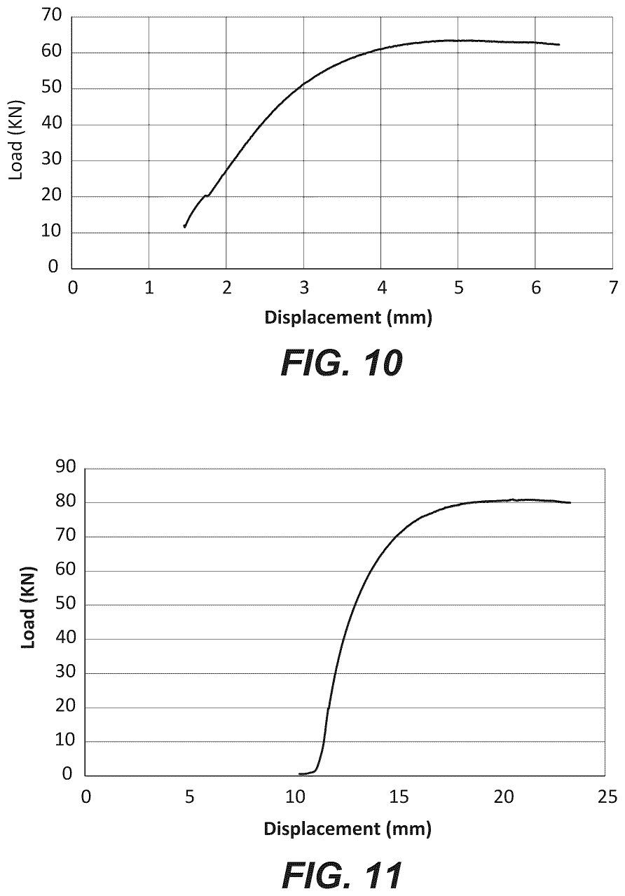

The composition or nanocomposite material can be used to increase bearing capacity of soil by injecting therein in the dry form, followed by heating. The composition can be used in repairing of rock cracks, especially in technical fields of oil wells and mining excavations. The composition can be used as concrete or in repairing concrete structures, particularly in closing cracks and providing interfacial bonding between cracks surfaces. FIG. 10 depicts a graph of load-displacement of concrete including the cement-free and water-free composition (with fine aggregates) under compression. FIG. 11 depicts a graph of load-displacement of concrete including the cement-free and water-free composition (with coarse aggregates) under compression.

In some embodiments, the composition is doubly pre-stressed. For example, the composition can be pre-stressed thermally and mechanically transversally and longitudinally if cast with reinforcement of steel. The composition forms a highly ductile bond with steel. CPNC expands during casting and contracts during cooling, producing prestressing and preventing crack formation with high interfacial bond with the steel. The composition can be functional, self-repairing. The composition can be suitable for 3D printing. The composition can be suitable for infrastructure components, like road pavement, painting and finishing, tiles, ceramics, soil stabilization, fire resistance, light weight bricks, etc.

According to embodiments of the present method, before casting, additional mixture contents can be determined based on desired strength and other properties. For example, molds can be coated internally by a very thin thermal coating layer to prevent bond formation between the mold walls and the composition (for example, aluminum foil). The mixture can be exposed to a suitable temperature to achieve melting of the polymer of the CPNC through heating by microwave, convection or other oven, or by any suitable technique to precast elements or by thermal mixers to achieve a melted mixture ready for casting into the mold. The molds may be, in an embodiment, metallic. The heating can continue for a certain time based on the required strength and required microstructure of the composite in addition to the dimensions of the structural elements. Then, the heating can be stopped and the composition can be cooled by exposure to the surrounding atmosphere or by an artificial (external) cooling. Cooling by the surrounding atmosphere can take time, which may be several hours, while using an artificial cooling technique can allow for rapid cooling in a shorter time. The resulting composition can start hardening directly when the cooling period starts.

In an embodiment, the aggregate material can be a very fine aggregate having a size that is near the size of the CPNC, in which case the aggregate and CPNC mix easily to achieve homogeneity.

The composition, prepared according to the above methods, can absorb thermal energy from heating and convert it to strain energy, which will produce bonding after cooling between aggregates reinforced with nanoclay. The composition can be prepared with steel reinforcement embedded therein in case of use in some structural elements. The composition binds strongly to steel reinforcement and is noncorrosive. The absorbed strain energy after cooling can resist any external stresses without fracture of crushing, but it may have some local deformations at high stresses with minimal loss of volume change strain energy. Mechanical testing of exemplary materials including the compositions was performed, as shown in the tables provided herein, with a ratio of CPNC to aggregate by weight of 5%-15%. The strongest material was produced with said ratio between 10% and 15% by weight.

The compaction ratio depends on the CPNC to aggregate ratio, where the compaction ratio changes between 5%-15% of the height of the samples. The compressive strength depends on the CPNC to aggregate ratio, heating temperature and heating time. After testing various samples including the composition described herein, no recognized cracks were observed, but deformation was seen with a maximum displacement of about 2.5%. The tested samples were re-heated for 2 hours and deformations were reversed. The samples were then retested for compressive strength and exhibited nearly 20%-50% increase of compressive strength.

In the prepared exemplary structural stabilizer, prestressing occurred when the cylindrical and cuboidal molds expanded with heating to a high temperature of about 220° C. With cooling, the molds contracted to their original size faster than the structural stabilizer, producing compressive prestressing smoothly on the nanocomposite, which increased the strength of the nanocomposite. The prestress helped avoid fracture, hair cracks and shrinkage cracks of the nanocomposite. The casting process for small size elements or large size elements were carried out easily and rapidly.

The structural stabilizer can be produced with no coarse aggregate, i.e., only fine aggregate, which is very homogenous, having no pores, defects or cracks. The structural stabilizer can be produced with no fine aggregate, i.e., only coarse aggregate. The structural stabilizer can be reinforced with CPNC wires, sheets, rods or bars, which have high tensile strength. The structural stabilizer resists sudden failure or crushing and may be used as an under-reinforced element or over-reinforced element due to its ductility.

As shown in the following examples, exemplary prepared structural stabilizer blocks demonstrate compressive strength in the direction of casting and compaction larger than that in an orthogonal or transverse direction by about 25%. This may be explained by arrangement of the aggregate in the microstructures as a layer. These layers may have differences in strength due to difference in the time of compaction and maximum reached temperature, which may affect bond strength. This can be accounted for, if desired, by mold design and explains variation in compressive strength of several samples.

The amounts of materials for the methods described herein are exemplary, and appropriate scaling of the amounts are encompassed by the present subject matter, as long as the relative ratios of materials are maintained. As used herein, the term “about,” when used to modify a numerical value, means within ten percent of that numerical value. The following examples illustrate the present teachings.

### EXAMPLES

The experiments described herein are funded only by grant number 13-ENV884-02 by National Plan of Science and Technology, King Saud University NPST & King Abdul-Aziz City for Science and Technology KACST. Grateful thanks to NPST, KACTS, and Bughshan research chair BRCES.

The following notations are used in the Examples herein.
CPNC Clay based polymer nanocomposite
Pᵤ Ultimate load
H cm Original Height before heat treatment
H′ cm Height after heat treatment (sintering)
W g Original Weight in gram
Vₒ Cm³ Original Volume before heat treatment
V′ Volume after heat treatment
g/cm³ gram/cubic centimeter
Hₒ cm Original Height before heat treatment in centimeter
Vₒ cm³ Original Volume before heat treatment in cubic centimeter
wₒ g Original weight before heat treatment in grams
H₁ cm Height after heat treatment (sintering) in centimeters
V₁ cm³ Volume after heat treatment in cubic centimeters
W₁ g Original Weight in gram in grams
ΔH cm Height reduction due to heat treatment and melting (displacement)
ΔH/Hₒ ratio of height reduction
γₒ g/cm³ Specific gravity before heat treatment
γ₁ g/cm³ Specific gravity after heat treatment
σ Compressive strength
W′ Weight after heat treatment

### Example 1

### Synthesis of Exemplary Composition for Demonstrating the Method

A standard test of compressive strength was performed on exemplary structural stabilizer samples. The test results are shown in Tables 1-6 below.

The test of compressive strength was carried out for coarse nanocomposite made of coarse aggregate only and CPNC, where the ratio of CPNC to coarse aggregate was 5%, 10% and 15% by weight. The coarse aggregate was kept from passing from sieve number 4 (4.75 mm), while the CPNC was made of HDPE, LLDPE and MMT with a ratio of 5% of nanoclay to polymer by weight. Compressive strength was found to be around 18 MPa, which is high strength in comparison with the comparable coarse aggregate concrete made of ordinary Portland cement and coarse aggregate. The tested cylinders were of dimensions (diameter=75-100 mm), (height=150-200 mm).

The test of compressive strength was carried out for a stabilizer made of coarse aggregate, fine aggregate (sand) and CPNC, where the ratio of CPNC to aggregate is 5%, 10% & 15% by weight. The sand was passed from sieve number 16 (1.19 mm), the coarse aggregate was restricted from passing through sieve number 4 (4.75 mm), while the CPNC was made of HDPE, LLDPE and MMT with a ratio of 5% nanoclay to polymer. A compressive strength=MPa was demonstrated, which is a high strength in comparison with the comparable conventional concrete. The tested cylinders are of dimensions (diameter=75-100 mm), (height=150, 200 mm).

The test of compressive strength was carried out for fine stabilizer made of sand and CPNC, where the ratio of CPNC to sand is 5%, 10% and 15% by weight. The sand size was restricted to sand passing from sieve number 16 (1.19 mm), while CPNC was made of HDPE, LLDPE and MMT with a ratio of 5% of nanoclay to polymer. Typical compressive strength was about 25 MPa, which is high strength in comparison with the comparable fine aggregate mortar made of ordinary Portland cement and sand.

From the exemplary structural stabilizer preparation and testing, the following was observed: no segregation, bleeding, or water evaporation; significant or large scale deformation; no crushing failure; and no observable cracks. Internal fracture of larger aggregate may have affected the compressive strength and mechanical properties. The aggregate size and shape are important factors for producing a homogenous and dense nanocomposite.

TABLE 1
Fine aggregate-CPNC (5%)-2(50 × 50 × 10 mm) cubes

| | | Cube | | H′ | | Volume | | Specific |
|---|---|---|---|---|---|---|---|---|
| | Pu | Strength | H | cm after | W | Vₒ | | gravity |
| No. | KN | N/mm² | cm | sintering | G | Cm³ | V′ | g/cm³ |
| 1 | 11.19 | 4.47 | 10 | 10 | 322 | 250 | 250 | 1.288 |
| | | | (2 × 5) | | | | | |
| 2 | 15.17 | 6.07 | 10 | 10 | 310 | 250 | 250 | 1.24 |
| | | | (2 × 5) | | | | | |
| 3 | 9.11 | 3.65 | 10 | 10 | 397 | 250 | 250 | 1.588 |
| | | | (2 × 5) | | | | | |

TABLE 2
(10%)-2(50 × 50 × 50 mm) cubes

| | | Cube | | H′ | | | | Specific |
|---|---|---|---|---|---|---|---|---|
| | Pu | Strength | | cm after | W | Vo | | gravity |
| No. | KN | N/mm² | H cm | sintering | Gm | Cm³ | V′ | gm/cm³ |
| 1 | 14.59 | 5.84 | 10 | 9 | 300 | 250 | 225 | 1.333 |
| | | | (2 × 5) | | | | | |
| 2 | 16.36 | 6.5 | 10 | 9 | 302 | 250 | 225 | 1.34 |
| | | | (2 × 5) | | | | | |
| 3 | 16.36 | 6.55 | 10 | 9 | 305 | 250 | 225 | 1.355 |
| | | | (2 × 5) | | | | | |

TABLE 3
Fine aggregate-CPNC (15%-2(50 × 50 × 50 mm)cubes

| | | Cube | | H₁ | | Volume | | Specific |
|---|---|---|---|---|---|---|---|---|
| | Pu | Strength | | cm after | W | Vₒ | | gravity |
| No | KN | N/mm² | H cm | sintering | G | Cm³ | V′ | g/cm³ |
| 1 | 58.5 | 23.4 | 10 | 7.5 | 266 | 250 | 187.5 | 1.418 |
| | | | (2 × 5) | | | | | |
| 2 | 31.2 | 12.5 | 10 | 7.5 | 273 | 250 | 187.5 | 1.456 |
| | | | (2 × 5) | | | | | |
| 3 | 21.76 | 8.71 | 10 | 7.5 | 273 | 250 | 187.5 | 1.456 |
| | | | (2 × 5) | | | | | |

TABLE 4
No Cement Coarse aggregate Concrete cylinders (No sand aggregate) and CPNC
(diameter 7.5 cm, height 15 cm)

| | Pᵤ | Cylinder | Cube | | | | Volume | | Specific |
|---|---|---|---|---|---|---|---|---|---|
| | Cylinder | Strength | Strength | H | | W | Vₒ | | gravity |
| No. | KN | N/mm² | N/mm² | cm | | Gm | Cm³ | V′ | gm/cm³ |
| 1-(5%) | 9 | 2 | 2.5 | 15 | 15 | 979 | 662.3 | 662.3 | 1.47 |
| 2-(10%) | 44 | 10 | 12.5 | 15 | 14 | 1121 | 662.3 | 618.1 | 1.8 |
| 3-(15%) | 47 | 10.65 | 13.35 | 15 | 13.5 | 1075 | 662.3 | 596 | 1.8 |

TABLE 5
Concrete (fine aggregate + coarse aggregate)-CPNC

| | Pu | Cylinder | Cube | | H′ cm | | Volume | | Specific |
|---|---|---|---|---|---|---|---|---|---|
| | Cylinder | Strength | Strength | | after | W | Vₒ | | gravity |
| No. | KN | N/mm² | N/mm² | H cm | sintering | G | Cm³ | V′ | g/cm³ |
| 1-(5%) | 35 | 8 | 10 | 15 | 15 | 1642 | 662.3 | 662.3 | 2.45 |
| 2-(5%) | 30 | 6.8 | 8.5 | 15 | 15 | 1653 | 662.3 | 662.3 | 2.49 |
| 3-(10%) | 51 | 11.55 | 14.45 | 15 | 14 | 1390 | 662.3 | 618.1 | 2.25 |
| 4-(10%) | 76 | 17.2 | 21.5 | 15 | 14 | 1326 | 662.3 | 618.1 | 2.145 |
| 5-(15%) | 70 | 15.85 | 19.82 | 15 | 13 | 1230 | 662.3 | 551.8 | 2.23 |

TABLE 6
Experimental work & testing of 2nd group of cylinders (D = 100 mm, H = 200 mm)
Materials = fine grinded coarse aggregate + sand + CPNC). Test speed = 0.4 mm/min.
Test is carried out at room temperature = 21 ° C.

| | CPNC | Ho | Vₒ | wₒ | H₁ | V₁ | W₁ | ΔH | ΔH/ | γₒ | γ₁ | Pu | N/ | W′ |
|---|---|---|---|---|---|---|---|---|---|---|---|---|---|---|
| No. | % | cm | cm³ | g | cm | cm³ | G | cm | Hₒ | g/cm³ | g/cm³ | KN | mm² | g |
| 1 | 5 | 24 | 1884 | 3294 | 23.5 | 1845 | 3235 | 0.5 | 0.02 | 1.75 | 1.753 | 42 | 5.2 | 2812 |
| 2 | 5 | 24 | 1884 | 3267 | 20.8 | 1632 | 2975 | 3.2 | 0.133 | 1.734 | 1.823 | 52 | 6.61 | 2858 |
| 3 | 10 | 24 | 1884 | 3724 | 18.3 | 1436 | 2696 | 5.7 | 0.2375 | 1.976 | 1.877 | 86.1 | 11 | 3005 |
| 4 | 10 | 24 | 1884 | 3586 | 22.8 | 1789 | 2845 | 1.2 | 0.05 | 1.9 | 1.589 | 29.6 | 3.8 | 2632 |
| 5 | 15 | 24 | 1884 | 2885 | 22.3 | 1750 | 2836 | 1.7 | 0.07 | 1.53 | 1.620 | 39.2 | 5 | 2709 |
| 6 | 15 | 24 | 1884 | 3321 | 19.3 | 1515 | 2655 | 4.7 | 0.196 | 1.763 | 1.75 | 53.4 | 6.8 | 2766 |

The stabilizer is self-compacting, since there is no compaction at any stage of the preparation method. As density depends on self-compaction, which depends on the shape and size of the aggregate and ratio of CPNC to aggregate, the exemplary fine aggregate and mixed aggregate structural stabilizer had a specific gravity of 1.5 gm/cm³ and the course aggregate structural stabilizer had a specific gravity of 1.7-1.8 gm/cm³. The fine aggregate structural stabilizer has very fine microstructure with very fine arrangement of particles without voids, defects, or micro or nano cracks. Therefore, it has high density with low specific gravity (low weight) and fine microstructure arrangement.

Compressive strength and mechanical properties have strong relationship to density. The density presumably is affected by any of shape and size of the aggregate, ratio of CPNC to aggregate, temperature and time of heating, type of CPNC, internal fracture of aggregate, arrangement of aggregate, dry mixing, method of heating, method of casting, method of cooling, time of cooling and ratio of nanoclay to polymer in CPNC. Mechanical properties may be chosen for based on these variables.

The ductile structural stabilizer is ecofriendly with functional properties, such as ductile, light-weight, fracture resistant, thermal resistant, crushing resistant, Portland cement free, corrosion resistant, self-compacting, dry mixing, high homogeneity, rapid hardening, high strength, and pollutant and contaminant free. The present subject matter can be applied for all construction purposes and structures especially in arid and semi-arid areas. It can be used for soil stabilization, oil wells stabilization, tunnels, mining excavations, sand dunes stabilization, repair of defected structures, roads and pavements, and many other fields. It produces no smell or smoke and requires no water for mixing or curing during preparation. It is prepared by a method featuring pressure-free sintering where there is no external load or pressure applied. The material weight produces self-compaction during casting free form or in a mold through heating until melting of the polymer of the CPNC. Cooling time can affect the casting time, strength, fracture toughness and material brittleness, where sudden cooling or rapid cooling will produce more brittle material with glassy behavior. The CPNC may be formed as a glass based on the glass transition of the polymeric composite used, during sudden cooling.

It is to be understood that the present composition is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A cement-free and water-free, ductile composition comprising:
a clay-based polymer nanocomposite comprising a polymer and exfoliated clay nanoparticles, the clay nanoparticles being dispersed in the polymer; and
an aggregate material comprising at least one of a fine aggregate and a coarse aggregate, the fine aggregate having a size ranging from about 0.5 mm to about 2 mm and the coarse aggregate having a size larger than about 2 mm.

2. The composition of claim 1, wherein
the polymer is at least one of high density polyethylene, medium density polyethylene, crosslinked polyethylene, ultra high molecular weight polyethylene, low density polyethylene and linear low density polyethylene.

3. The composition of claim 1, wherein
the polymer includes at least one of high density polyethylene and linear low density polyethylene.

4. The composition of claim 1, wherein
the aggregate material comprises a fine aggregate.

5. The composition of claim 1, wherein
the aggregate comprises a coarse aggregate.

6. The composition of claim 1, wherein
the aggregate comprises a fine aggregate and a coarse aggregate.

7. The composition of claim 1, wherein
the clay nanoparticles comprise at least one of montmorillonite clay nanoparticles and halloysite clay nanoparticles.

8. The composition of claim 7, wherein
the montmorillonite clay nanoparticles are in the form of nanoplatelets.

9. The composition of claim 7, wherein
the halloysite clay nanoparticles are in the form of nanotubes.

10. The composition of claim 1, wherein
a weight ratio of the clay nanoparticles to polymer is in the range of about 1-20%.

11. The composition of claim 10, wherein
a weight ratio of the clay nanoparticles is about 5%.

12. The composition of claim 1, wherein
a weight ratio of the aggregate material to the clay-based polymer nanocomposite can be about 1-30%.

13. The composition of claim 1, wherein
a weight ratio of aggregate to the clay-based polymer nanocomposite combined is about 5-20%.

14. The composition of claim 1, wherein
the aggregate material comprises at least one of soil and sand obtained from a natural or agricultural environment.

15. Concrete comprising the composition of claim 1.

16. The concrete of claim 15, wherein the concrete is self-compacting.

17. The concrete of claim 15, wherein the concrete is self pre-stressing.

18. The concrete of claim 15, wherein the concrete is resistant to steel-corrosion.

19. A method of preparing a composition comprising:
providing a powder of a clay-based polymer nanocomposite, the clay-based polymer nanocomposite comprising a polymer and clay nanoparticles, wherein the clay nanoparticles are exfoliated and dispersed in the polymer;
mixing the powder with an aggregate comprising at least one of a fine aggregate and a coarse aggregate to form a mixture; and
heating the mixture to a temperature at which the polymer of the clay polymer nanocomposite melts.

20. The method of claim 19, further comprising
casting the heated mixture in a mold coated with aluminum foil.
